(19) United States
(12) Patent Application Publication
(10) Pub. No.: US 2012/0129130 A1
(43) Pub. Date: May 24, 2012

(54) Torque wrench and kit for implant dentistry

(76) Inventor: Jeffrey Ruff, New City, NY (US)

(21) Appl. No.: 12/927,813

(22) Filed: Nov. 24, 2010

(51) Int. Cl. A61C 8/00

(52) U.S. Cl. 433/147

(57) ABSTRACT

A wrench for a installing a support member for a prosthesis including a body, rotating cylinder in the center, and cap. The cylinder has a cap on one end and a driver on the other. The bottom of the cap has radially disposed ridges and grooves. The body has bores therein, each with a spring and rotatable ball. Each ball protrudes from a bore and is in contact with a groove.

When the cap is rotated each ball is in a groove and the cap, body and driver rotate together, to install the support member. When a maximum torque is obtained, each ball is depressed causing the cap to rotate preventing further installation of the member.

A kit includes several wrenches and drivers, each wrench having a different maximum torque and each driver having a different tip configuration.

### BACKGROUND OF THE INVENTION

1. Field of the Invention

The present invention relates to the field of dental implantology and, more specifically, to a dental driver tool, i.e., a torque wrench, for manually driving a dental implant support member into an implant that was placed into a surgical site in a jawbone of a patient. Broadly, this invention relates to a torque wrench and driver system that can be used with most commercially available implant systems. More specifically, this invention relates to a torque wrench for applying a selected (predetermined) maximum torque during installation of a dental implant support, e.g., abutments and screws, into a dental implant, and a kit that includes a plurality of such torque wrenches with differing predetermined maximum torques, a mating wrench, and a plurality of interchangeable drivers with various configurations of tips for use with different configurations of supports, abutments and screws.

2. Related Art

Implant systems consisting of an implant or root portion embedded in a patient's bone and tissue and an abutment or support device for receiving a prosthesis are widely used. Typically, a dental implant fixture is implanted in a cylindrical bore made in the alveolar ridge crest of a patient's jawbone after the gum tissue has been displaced. The fixture typically includes an internally-threaded cylindrical socket which receives one or more components used for attaching a permanent dental restoration to the fixture. The components typically include an abutment base in the form of a short tubular body having a transverse wall at a first end thereof shaped to mate with the gingival aspect of a transverse surface of the implant fixture. The abutment base has a bore therethrough for receiving an abutment screw used to retain the abutment base to the fixture. A dental restoration, in the form of an anatomical overlay, is adapted to be fabricated to the abutment.

More specifically, in installing a threaded dental prosthesis or implant into the jawbone of a patient, the gingival tissue is incised exposing the jawbone. A series of drills are then used to form a cylindrical bore in the jaw bone (osteotomy) and prepare the site for the dental implant. Threads are tapped into dense bone and the dental implant is then either press-fit or screwed into the prepared hole with a driving tool. During the implantation procedure, a manual, electrical, air-driven or hand-held driving tool can be used to drive the dental implant into the osteotomy. At this point the gingiva is sutured over the implant and allowed to integrate with the bone over a period of time, e.g., typically three to nine months. Subsequent to such integration, the implant is located, the gingival tissue is excised and the healing cap is screwed into the implant.

It has been found that it is extremely important that the abutment be installed to proper torque limits. Clinical experiments have revealed that proper installation torque is important to the quality of the installed dental prosthesis. Too much torque may over stress or strip the bone, dental screw, implant or abutment. Insufficient torque will not ensure a sufficient securement into the bone, possibly causing the screw or abutment to loosen, requiring a follow up re-tightening procedure.

Typically, a torque of around 10 Newton-centimeters (N-cm) (0.886 inch-pounds, or 0.074 foot-pounds) is used to install a cover screw. Typically, the dental implant, after subsequent re-exposure, has osseo-integrated into the jaw bone. After removal of the cover screw or healing cap, an abutment is securely attached to the implant to provide a foundation for the actual dental prosthesis or crown. The abutment is either a one-piece screw-in type or held on the implant with a separate screw, both installed to a particular torque limit. The torque at which the abutment is installed is about 20 to 35 Newton-centimeters. The dental prosthesis is then usually cemented onto the abutment.

To accomplish this process several torsional ratchet tools have been designed. The use of ratchet type wrenches for installation of abutments and screws offers relatively little advantage over the straight shank direct application screwdrivers. The ratchet action offers less control because it interferes with the “feel” or tactile sensitivity of the installation, and the ratcheting movement introduces undesirable instability in a sensitive procedure. In ratcheting, the dentist is also unable to get the desired tactile feedback regarding torque resistance of the meshing threads, etc. The use of screwdriver bits on electrical dental handpieces is likewise undesirable because of the complete loss of tactile sensitivity with the attendant risk of either breaking the screw or spinning the implant in the bone. In some of these tools, a few incorporate a breakaway feature when a predetermined torque is exceeded to prevent the seating tool or screw from stripping.

The inventor is aware of the following prior art:

U.S. Pat. No. 5,129,823 to Hughes describes a tool for the installation of an abutment or screw in implant dentistry. The tool has a manually rotatable knob external to the patient's mouth on one end of an arm and a bit, releasably secured on a sprocket, rotatable inside the patient's mouth in response to rotation of the knob. Multiple interchangeable bits are provided to match different sized abutment or screw heads.

U.S. Pat. No. 5,295,831 to Patterson et al describes a torque wrench particularly suited for applying a selected maximum torque to a dental implant. The wrench is constructed of a single shaft of with an undercut or relieved portion therein such that application of a predetermined torque to the dental implant through the shaft produces a deformity in the shaft at the relief.

U.S. Pat. No. 5,337,638 to Coss et al describes a torque wrench for procedures requiring the application of precise small torques. The wrench includes a handle pivotally connected to a cam member rigidly attached to a driving head. The handle breaks out of alignment with the extending cam member upon application of an adjustable torque limit. A spring-biased plunger within the handle normally holds a rigid ball within an elliptical indent in the cam member. Application of the torque limit on the handle forces the ball out of the indent and limits the further pivot of the handle.

U.S. Pat. No. 5,368,480 to Balfour et al describes a low profile dental torque ratchet system having a disposable breakaway color-coded insert for holding a tool to be driven by a torsional ratchet wrench. Incorporated within the ratchet wrench is a driver that drives the tool until a preset torsional force shears the insert.

U.S. Pat. No. 5,626,474 to Kukla et al describes a manually operated dental implant torque wrench having an adjustable torque limiting assembly that disengages the torquing ability of the wrench when a predetermined torque setting has been reached having a torque limiting assembly that is adjustable to varied torque settings.

U.S. Pat. No. 6,007,336 to Sapkos describes a support device or post for fitting into an implant implanted into a patient which is configured to support a dental prosthesis is provided. An upper portion of the post, in one embodiment, has external screw threads for coupling a healing cap. The upper portion of the post may be removed or broken away at a weakened portion or constriction. The support device has a collar which can define various heights or diameters. The support device can be positioned in the implant by mating screw threads with the support device being torqued to a predetermined torque, preferably using a torque wrench which can be set using a non-variable, preferably gravity-based, standard.

U.S. Pat. No. 6,162,053 to Hollander describes a dental torque wrench wherein at a given level of torque imparted to a dental work object the handle rotates to an off-axis position relative to a longitudinal work axis. This disables the wrench head precluding further application of a torque to the work object.

U.S. Pat. Nos. 6,186,785 and 6,398,552 to Rogers et al describes a ratchet wrench and a torque indicator combined concentrically in a single housing. The ratchet wrench is used for driving a fastener used in dentistry, such as an abutment screw that holds an abutment on a dental implant. In operation, the handle of the wrench can be rotated in one direction (e.g., clockwise) to impart torque on the fastener. When the handle is rotated in the opposite direction (e.g., counterclockwise), no torque is applied to the fastener as the handle is returned to a position where it is easy for the clinician to again rotate the handle to apply additional torque to the fastener. To provide an indication of torque, a rotor body is supported coaxially within the driver member. Torque indicator marks on the rotor body and the driver member indicate angular displacement of the driver member around the common axis relative to the rotor body when a tool held in the rotor body is restrained from turning under load.

U.S. Pat. No. 6,957,959 to Kumar et al describes a manual dental driving tool adapted to drive a dental implant into the jawbone of a patient. The driving tool includes a handle at the proximal end, a ratchet assembly and a pin assembly located within the handle, and a tool engaging assembly located at the distal end. The pin assembly switches the driving tool between a manual mode and a ratchet mode.

U.S. Pat. No. 7,100,476 to Feit describes a manually-operated, adjustable dental implant torque wrench employs a screw holding sheath for placing a dental screw in a mouth of a patient. A handle offset to avoid opposite teeth to the work area is provided with a bevel gear and pinion set to translate the turning motion from a straight turning shaft in the handle to a perpendicular screw turning head. An assortment of replaceable snap-fit screw turning heads fits the various types of dental screws. An easy turn T-shaped handle with a pivotable turning knob is controlled by a torque limiting device.

US 2006/0008770 to Brajnovic et al describes a dental screwing arrangement.

US2008/0070190 to Baumgartner describes a torque ratchet wrench used in dentistry which is embodied as a ratchet instrument in dental prosthetics.

Also known in the art is the BIOMET 3i low torque indicating ratchet wrench (L-TIRW) that is a manual driver for inserting components and a torque indicator to provide a visual assessment of the torque. (Biomet 3i LLC, Palm Beach Gardens, Fla.).

The present invention provides an improved torque-limiting tool for highly accurate applications which overcomes the deficiencies of prior art wrenches.

### OBJECTS AND SUMMARY OF THE INVENTION

It is an object of this invention to provide a unique hand-operated driving tool for the installation of threaded supports, abutments and screws in implant dentistry.

It is a further object of the invention to provide a tool of the above type having a low profile and that is particularly suitable for use in clinical spaces, particularly implant dentistry.

It is another object of the invention to provide a unique torque limited wrench having particular application in the area of implant dentistry.

It is a more specific object of this invention to provide a torque wrench for applying a selected (predetermined) maximum torque during installation of supports, e.g., abutments and screws for a dental implant.

It is yet another object of the present invention to provide a system for driving components of a dental restoration system that precisely and reproducibly tightens components to a specified torque in a simple and cost-effective way.

It is still another object of this invention to provide a system for driving components in a dental restoration system that can be used with a variety of different makes and styles of component parts.

It is yet another object of this invention to provide a dental implant kit that includes a plurality of unique torque limited wrenches with differing predetermined maximum torques, a mating wrench, and a plurality of interchangeable drivers with various configurations of tips for different configurations of supports, abutments and screws.

It is yet a further object of this invention to provide such a system that has little or no maintenance and which includes disposable elements for exacting torque control reliability.

All of the objects of this invention are achieved by the torque wrench and associated accessories for such wrench. Broadly the preferred embodiment of this invention includes a torque wrench to which a driver member is attached. The driver is used for threadably installing, to a predetermined torque, a support member for a dental prosthesis. The wrench includes a torque wrench body having a proximal end and a distal end. A cylindrical member is provided that passes through the center of the wrench body, the wrench body being axially rotatable therein.

A torque wrench cap is provided for placement on the proximal end of the wrench body. The cap has an upper surface and a lower surface. The wrench cap is fixedly mounted to the proximal end of the cylindrical member. The lower surface of the wrench cap has a plurality ridges and grooves radially disposed therein. The wrench cap when placed on the wrench body is axially rotatable thereon.

The wrench body has at least one, and preferably a plurality, of axially disposed cylindrical bores therein. Each bore has a closed bottom on one end and an opening on the other end at the proximal end of the wrench body. A compression spring member is in each bore with a rotatable ball thereon supported on the spring member. In use, a portion of each ball protrudes from the opening and is in springed contact with a groove in the lower surface of the wrench cap. A driver member is removably mounted to the distal end of the cylindrical member to secure the driver to the distal end of the torque body.

In use when the wrench cap is rotated, each of the rotatable balls is springedly secured to the groove in the lower surface of the wrench cap to permit both the wrench cap and body and driver to axially rotate together to threadably install the support member. When the support member is threadably installed to the predetermined torque the ball is depressed by the ridges in the lower surface of the cap, compressing the spring in the bore, and the torque cap rotates with respect to the torque body to prevent further threadable installation of the support member.

In a preferred embodiment a torque wrench kit is provided comprising a plurality of the combination torque wrenches and a plurality of the drivers, each torque wrench capable of threadably installing a support member to a different predetermined torque and each driver having a differing tip configuration to couple to a different support member.

The foregoing outlines some of the relevant objects of the present invention. These objects should be construed to be merely illustrative of some of the more prominent features and applications of the invention. Many other beneficial results can be attained by applying the disclosed invention in a different manner or modifying the invention. Accordingly, other objects and a fuller understanding of the invention may be had by referring to the following Detailed Description of a preferred embodiment.

### BRIEF DESCRIPTION OF THE DRAWINGS

Other important objects and features of the invention will be apparent from the following Detailed Description of the Invention taken in connection with the accompanying drawings in which:

FIG. 1. A perspective view of the novel torque wrench of this invention and mating wrench mounted on a driver for tightening an abutment, i.e., support member into an implant (clockwise rotation), the torque wrench having a maximum torque as indicated by the indicia of 25 Newtons-cm (N-cm).

FIG. 2. A perspective view of the novel torque wrench of this invention detached from the driver, with the mating wrench attached to the driver to remove the abutment from the implant (counterclockwise rotation).

FIG. 3. An exploded perspective view of the torque wrench and driver of this invention used on the abutment or support member.

FIG. 4. An exploded side view of the torque wrench and the driver of this invention.

FIG. 5. A side view of the torque wrench of this invention secured to the driver.

FIG. 6. An axial cross-sectional view of the torque wrench of this invention secured to the driver.

FIG. 7. A bottom plan view of the driver with a hexagonal tip for attachment to the support member that is to be driven by the torque wrench.

FIG. 8. A top view of torque wrench body with the torque wrench cap removed showing the spherical balls (e.g., nylon) mounted in the spring bores.

FIG. 9. A-C. A bottom view of several embodiments of the lower surface of the torque wrench cap showing varying ridges and grooves that assist in providing the various predetermined torques for the torque wrench of this invention.

FIG. 10. A partial axial cross-sectional view of the lower surface of the driver cap showing the ball resting on the compression spring and engaging the groove in the lower surface of the cap to prevent slippage of the wrench cap over the wrench body to enable the support member to be tightened.

FIG. 11. A partial axial cross-sectional view of the lower surface of the driver cap showing the ball being forced down onto the compression spring after a predetermined maximum torque is achieved to permit slippage of the wrench cap over the wrench body to prevent the support member from being over tightened.

FIG. 12-14. Partial axial cross-sectional views of several embodiments of the lower surface of the torque wrench driver cap showing varying internal ridges and grooves that assist in providing various predetermined maximum torques to the torque wrench of this invention.

FIG. 15. A top plan view of the torque wrench of this invention.

FIG. 16. A bottom plan view of the torque wrench and mating wrench of this invention in use, mounted on a driver.

FIG. 17. Cross-section taken along line 17-17 of FIG. 18. of the central bore, e.g., a threaded brass cylinder, passing through the center of the body of the torque wrench of this invention.

FIG. 18. Axial cross-section of the central bore, e.g., a threaded brass cylinder, passing through the center of the body of the torque wrench of this invention.

FIG. 19. The nylon balls used in the torque wrench of this invention.

FIG. 20. A schematic of components of the torque wrench kit of this invention comprising a plurality of torque wrenches, plurality of drivers and a matching wrench, each torque wrench capable of threadably installing a support member to a different predetermined torque and each driver having a differing tip configuration to couple to a different support member.

FIG. 21. Various configurations of driver tips that can be included in the kit of this invention.

Throughout the drawings, like elements are referred to by like numerals.

### DETAILED DESCRIPTION OF THE INVENTION

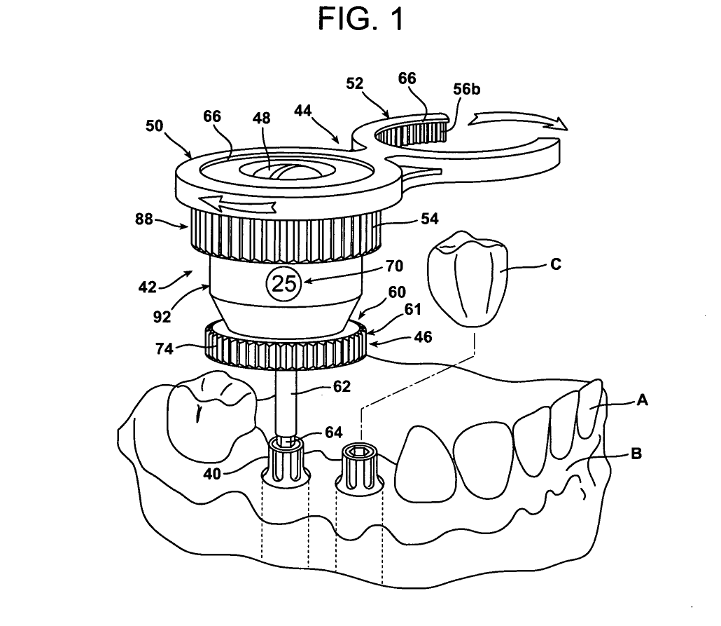

Referring to FIG. 1, this invention relates to fabricating and/or installing a prosthesis into patients. The prosthesis is usually a temporary healing cap or permanent dental crown C. A hollow receiving device or “implant” is implanted into a patient, usually into the patient's jaw bone (alveolar). A support device or “abutment” is fitted into the implant and extends upwardly away from the jaw bone for receiving a healing cap and/or a permanent prosthesis.

Again referring to FIG. 1, the present invention is directed to a dental driver tool, i.e., torque wrench 42, for manually driving an abutment 40 onto an implant that was placed in a prepared surgical site in a jawbone B of a patient. The abutment 40 is screwed into the implant and the crown C placed over the abutment 40. A number of materials can be used for making the abutment 40, including gold or titanium. The crown C is shown just prior to placement or cementing onto the abutment adjacent the existing teeth A. More specifically, torque wrench 42 of this invention applies a selected (predetermined) maximum torque during installation of supports 40, e.g., abutments and screws, onto a dental implant.

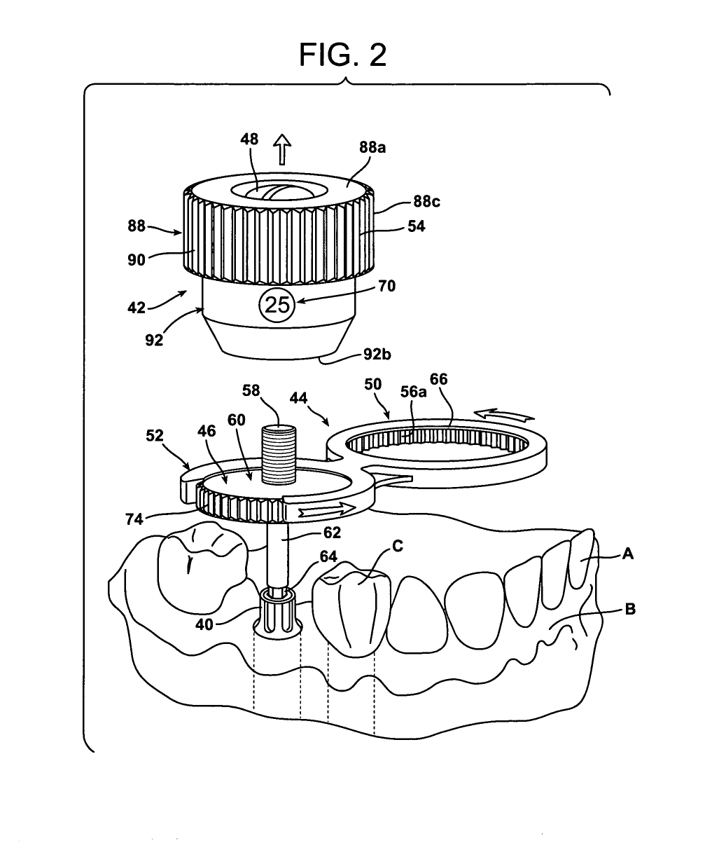

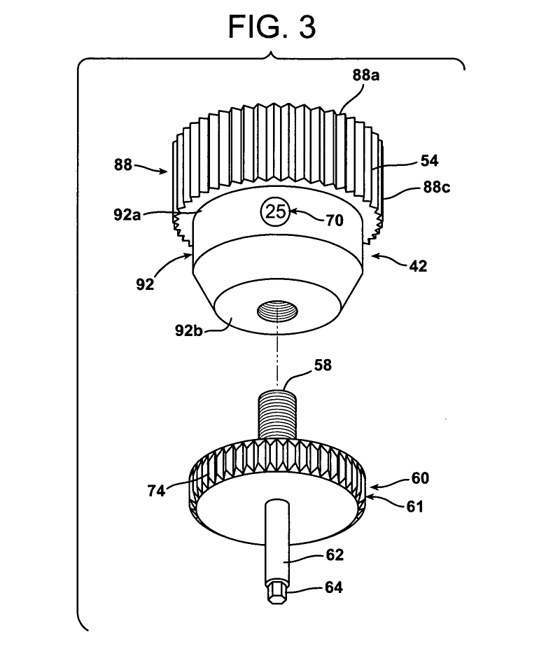

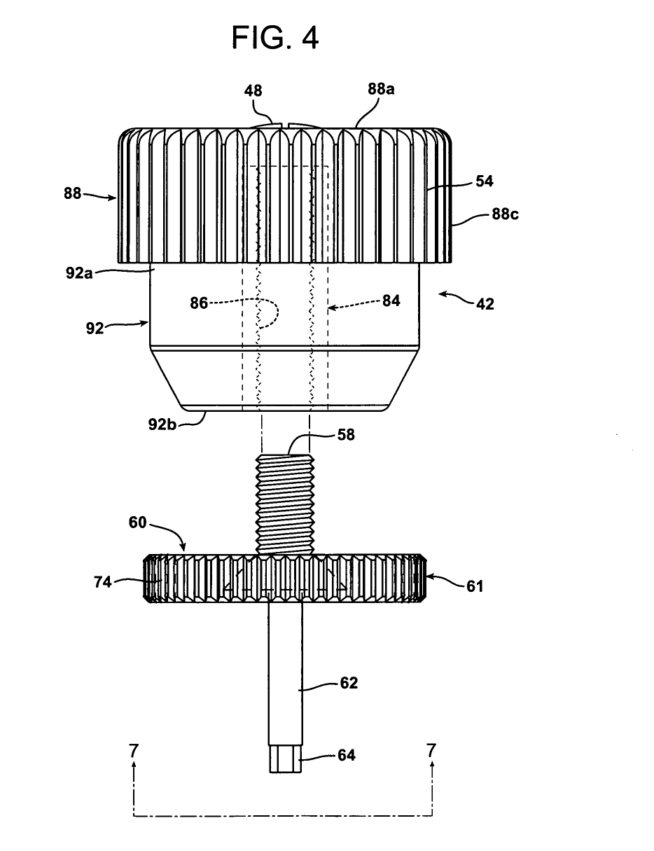

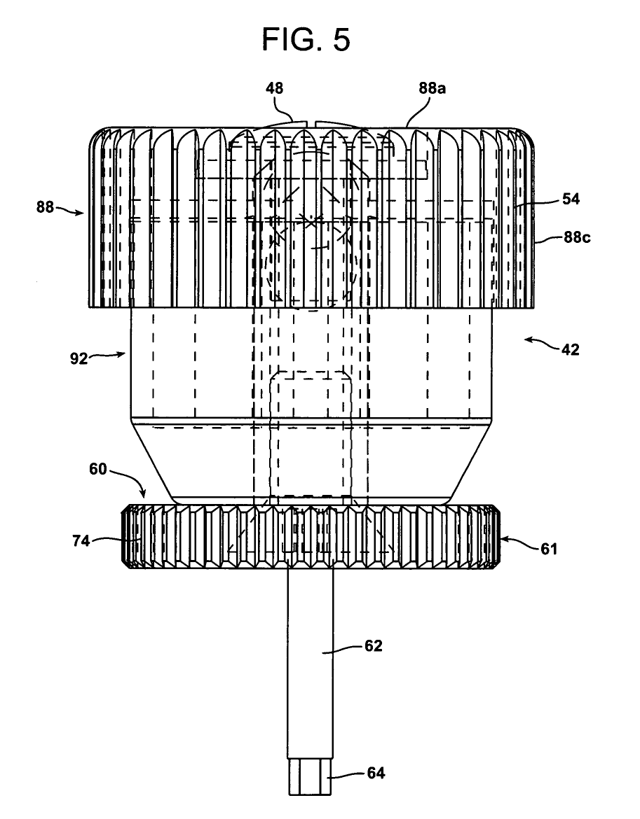

Referring to FIGS. 1-6, the torque wrench 42 has a driver member 46 attached thereto for threadably installing to a predetermined torque, a support member 40 for a dental prosthesis.

The torque wrench 42, which is shown in its preferred embodiment in the Figures, broadly has a cylindrical shape. It should be understood, that although not preferred for use or manufacture, other shapes, e.g., square, oblong, hexagonal, octahedral, etc., may also be used without changing the concept of this invention. The torque wrench can be made from any suitable materials, i.e., polymers or metals that are suitable for dental work, and if desired, autoclavable for reuse. Such materials are well known in the art.

The torque wrench 42 comprises a torque wrench body 92 having a proximal end 92a and a distal end 92b. To put this invention in perspective, in its preferred embodiment the height of the torque wrench body, i.e., distal end to proximal end, is about 0.4 inches and has a maximum diameter of about 0.5 inches.

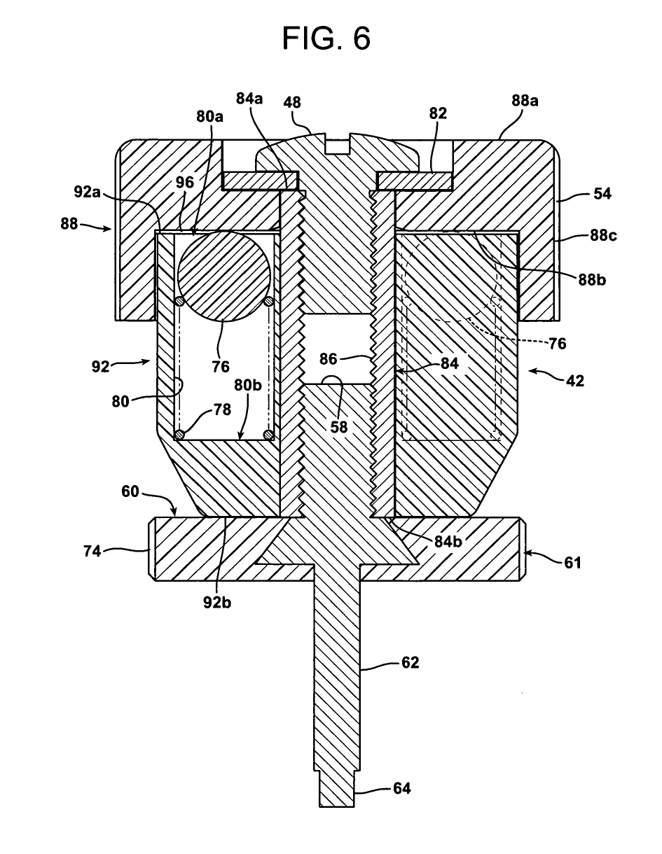

Referring to FIGS. 6 and 18, a cylindrical member or tube 84 is provided. The tube 84 has a proximal end 84a and a distal end 84b. This tube 84 passes through the center of the wrench body 92. The distal end 84b passes through and is flush with the distal end 92b of the wrench body 92. The tube 84 also passes through and projects above the proximal end 92a of the wrench body 92. The tube 84 is axially rotatable within the wrench body 92. To again put things in perspective, in the preferred embodiment the tube 84 is made of brass and is about 0.156 inches in its outer diameter and projects about 0.06 inches above the proximal end 92a of the torque wrench 92. The cental tube 84 is threaded 86 in the interior of the tube 84, at least at the ends 84a, 84b thereof. However, for ease of manufacture the tube 84 is threaded 86 the complete length of the tube 84.

Referring to FIG. 6, the torque wrench cap 88 is of a size and shape for placement on the proximal end 92a of the wrench body 92 and is axially rotatable with respect to the wrench body 92. The wrench cap 88 has an upper surface 88a and a lower surface 88b. The wrench cap 88 is fixedly mounted to the proximal end 84a of the cylindrical member 84. In the preferred embodiment this is accomplished by providing a hole through the proximal end 88a (upper surface) of the cap 88 through which a screw 48 is passed that rests on a washer 82. The screw 48 threadably engages the threads in the cylindrical member 84 at the proximal end 84a to secure the cap 88 thereto.

Referring FIGS. 1-4, 9 and 20, the wrench cap 88 has a sidewall 88c connecting the upper surface 88a and lower surface 88b. The sidewall 88c has axial disposed grooves 54 running vertically on the sidewall 84c. The grooves 54 are equidistant from each other. Such grooves 54 permit the controlled grasping of the cap 88 with the fingers, i.e., acting as knurling thereon. However, more importantly the grooves 54 permit a matching wrench 44 having matching grooves 56a in the head 50 to be placed over the cap 88 to couple and interlock with the sidewall 88c of the wrench cap 88. Typically, the matching wrench 44 is used to tighten the torque wrench 42 to its maximum predetermined torque.

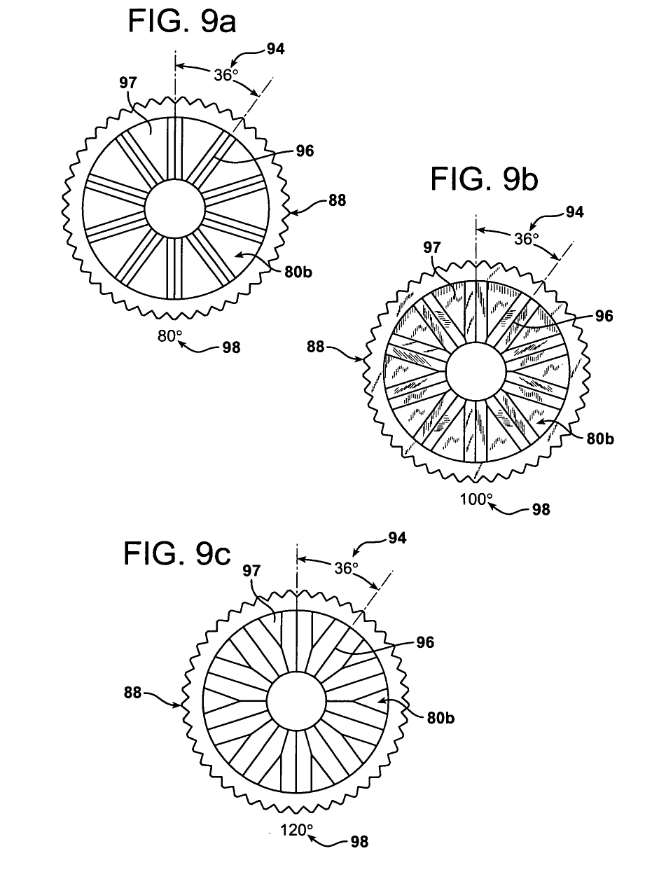

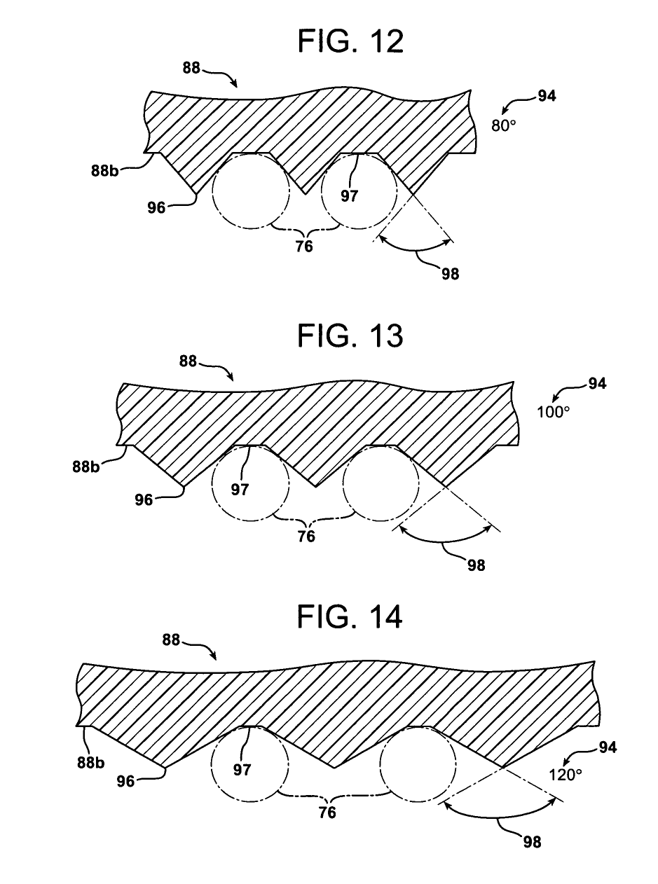

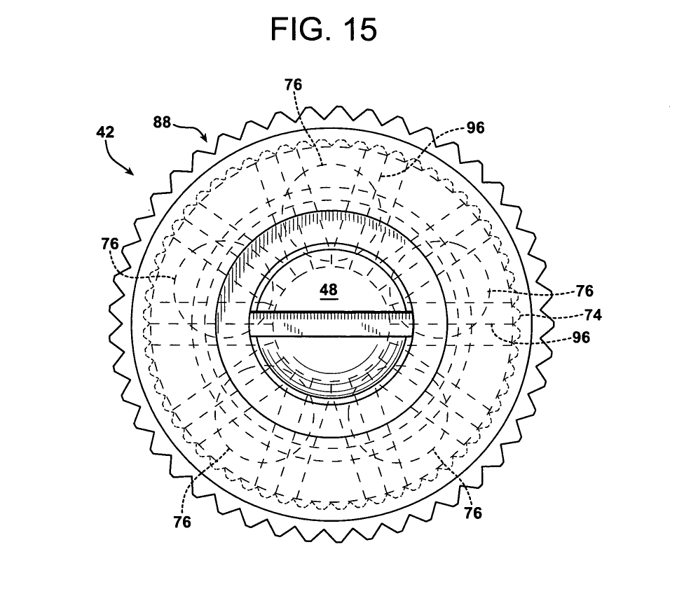

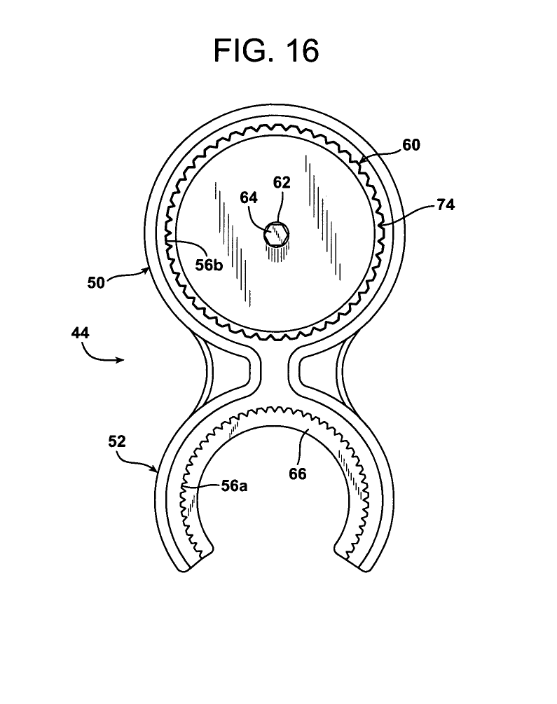

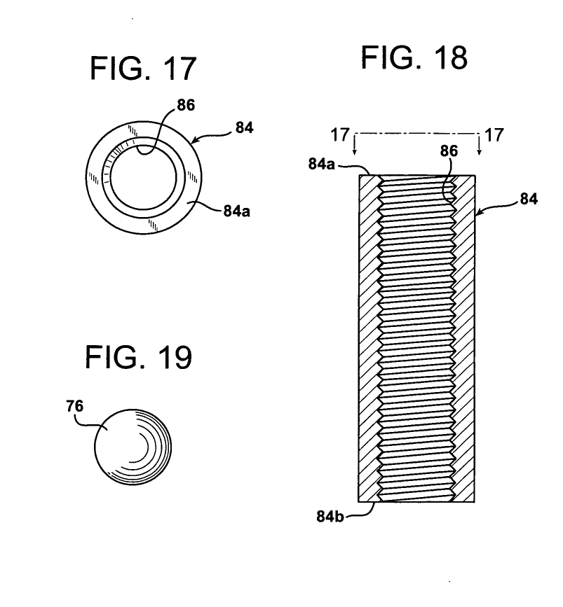

Referring to FIGS. 9-14, the lower surface of the wrench cap 88b has a plurality ridges 96 and grooves 97 radially disposed therein. In the preferred embodiment the angle 94 between adjacent ridges 96 is 36°, thus providing ten (10) ridges 96 and ten (10) grooves 97. As indicated in FIGS. 12-14, the angle of the ridge 98, in the preferred embodiments, varies between 80° and 120°. The higher the angle, the lower the maximum predetermined torque developed. FIGS. 9a, 9b and 9c show the bottom view of the lower surface 88b of the torque wrench cap 88 view of these embodiments showing varying ridges 96 and grooves 97 for such varying angles 98.

It should be understood the number of ridges 96 and grooves 97, combined with the angle of the ridge 98 (see FIG. 12-14), the type and diameter ball 76 and spring 78 force may all be adjusted to provide the desired predetermined torque for the wrench 42.

Referring to FIGS. 6, 8, 10, 11 and 19 the wrench body 92 has at least one cylindrical bore 80 therein. Preferably, there is a plurality of cylindrical bores 80 circumferentially distributed equally about the central axis 93 of the wrench body 92. In the preferred embodiment, there are five (5) bores 80 circumferentially distributed equally about the central axis 93 of the wrench body 92. Each bore 80 has a closed bottom 80b and an open top 80a at the proximal end 92a of the wrench body 92. Again, for perspective in the preferred embodiment the bore 80 is 0.135 inches in diameter and is of a height about 0.287 inches.

Referring to FIG. 6, a compression spring member is seated in the bore 80. The specifications for the spring can be readily determined by one skilled in the art and depend on the specific diameter bore 80, ball type and diameter 76, grooves 97, ridges 96 and other factors. In the preferred embodiments the following examples of compression springs with the following specifications, may be used:

Gardner Spring #36006GS
Outside Diameter: 0.1200 inches
Wire Size: 0.022 inches
Free Length: 0.250 inches
Spring Rating: 60.800 lbs.
Maximum Workload: 5.21 lbs.
Material: Stainless Steel

MSC Industrial Supply Co. Spring #03307733
Outside Diameter: 0.1200 inches
Wire Size: 0.020 inches
Free Length: 0.250 inches
Spring Rating: 40.330 lbs.
Maximum Workload: 2.83 lbs.
Material: Stainless Steel

It should be understood that other springs and spring types may be used.

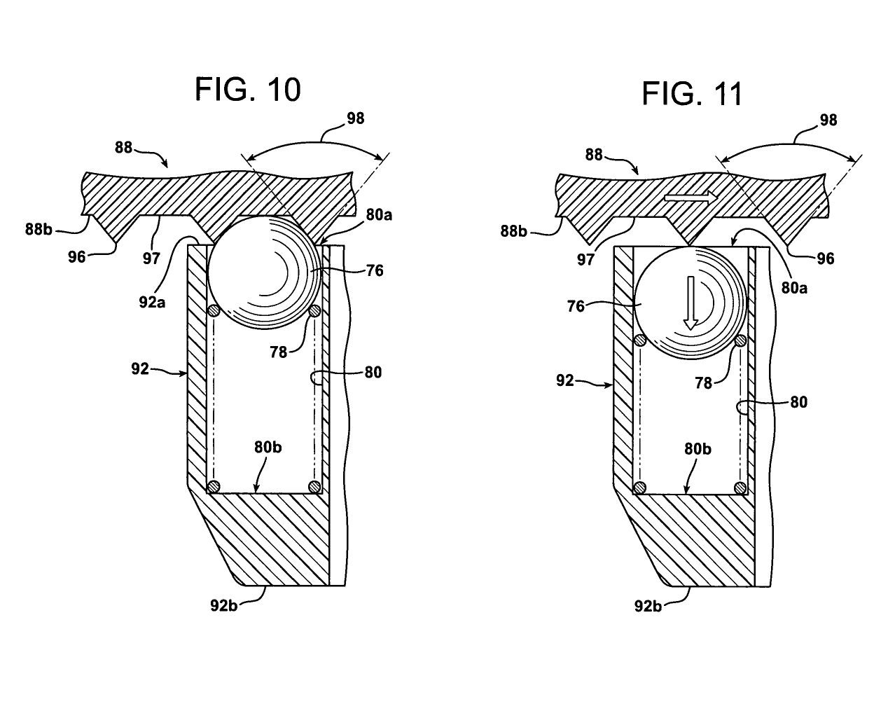

Referring to FIGS. 6, 8 and 10-14 and 19, a rotatable spherical ball 76 is within the bore 80 and supported on the compression spring member 78. Referring to FIG. 10, a portion of the ball protrudes from the opening 80a and is in springed contact with a groove 97 in the lower surface 88b of the wrench cap 88.

In the preferred embodiment the balls used having the following specifications:
Material: Delrin Acetal Material, Solid, Smooth Finish
Diameter: ⅛″
Diameter Tolerance: ±0.001″
Opaque White
Operating Temperature Range Up to +185° F.
Tensile Strength: Good
Impact Strength: Good
Tolerance: Standard
Grade: 1
Hardness: Rockwell M: 89-94
Sphericity: 0.0005″
Specifications Met: Food and Drug Administration (FDA) Compliant, National Sanitation Foundation (NSF) Compliant, U.S. Department of Agriculture (USDA) Compliant

It should be understood that other balls and ball types may be used.

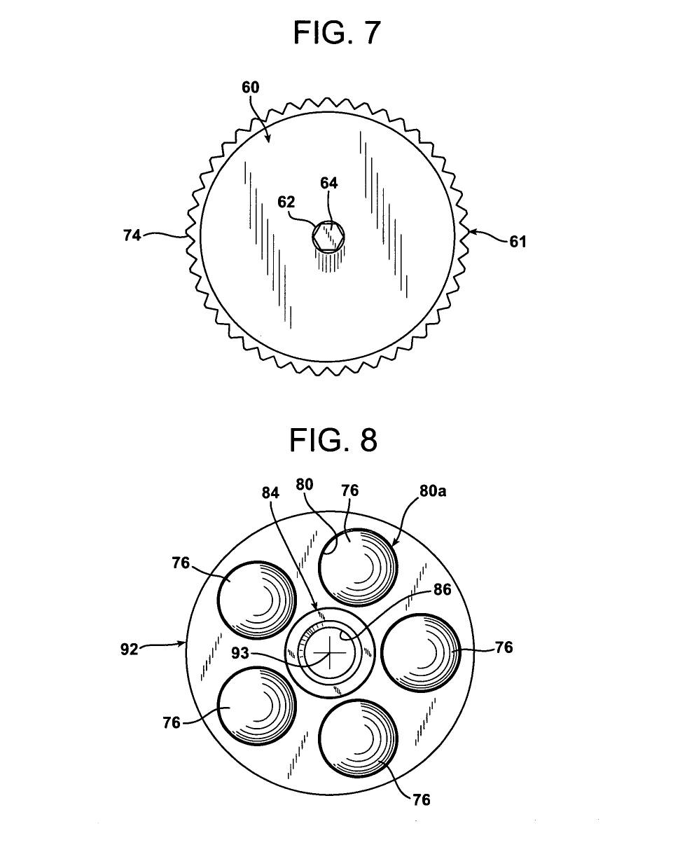

Referring to FIGS. 1-7 and 20-21a driver member 46 is removably mounted in the distal end 84b of the cylindrical member or tube 84 to secure the driver 46 to the distal end 92a of the torque wrench body 92. In the preferred embodiment depicted, the driver 46 has a threaded proximal end 58 that threads into the distal end 92a of the central cylindrical tube 92. The driver proximal end 58 is threaded into the tube 84 until the driver head 60 abuts the distal end 92b of the wrench body 92.

Preferably the driver head 60 has a sidewall 61 having axial grooves 74 therein that are equidistant from each other. Such grooves 74 permit the controlled grasping of the driver head 60 with the fingers, i.e., acting as knurling thereon. However, more importantly the grooves 74 permit a matching wrench 44 having matching grooves 56b in wrench end 52 to be placed over the head 60 to couple and interlock with the sidewall 61 of the head 60.

In yet another embodiment, it is envisioned that the torque wrench cap 88 and driver head 60 are cylindrical and substantially the same diameters, each having substantially identical axial grooves 54 and 74. This permits a matching wrench 44 to have only one wrench head (50 52) that fits both the wrench cap 88 and driver head 60.

Referring to FIGS. 6, 10 and 11, when the wrench cap 88 is rotated, the rotatable balls 76 in the wrench body 92 are springedly secured in the grooves 97 the wrench cap 88 (FIG. 10). This causes the wrench body 92, the wrench cap 88 and driver 46 to axially rotate to threadably install the implant support member 40. Referring to FIG. 11, when the support member 40 is threadably installed to the predetermined torque, the ball 76 rolls over the ridges 96 and is depressed into the bore 80 compressing the spring 78 permitting the wrench cap 88 to rotate or slip with respect to the wrench body 92 to prevent further threadable installation of the support member 40.

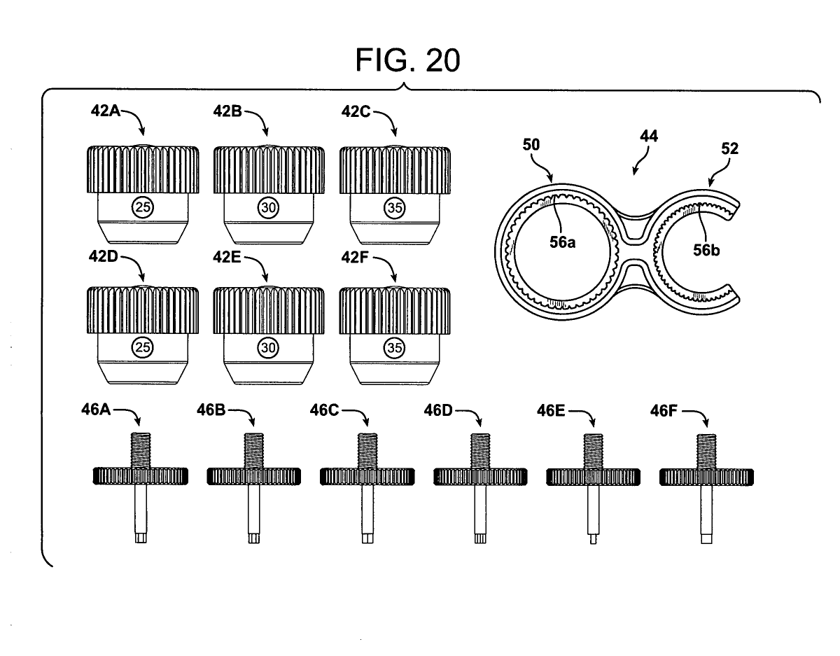

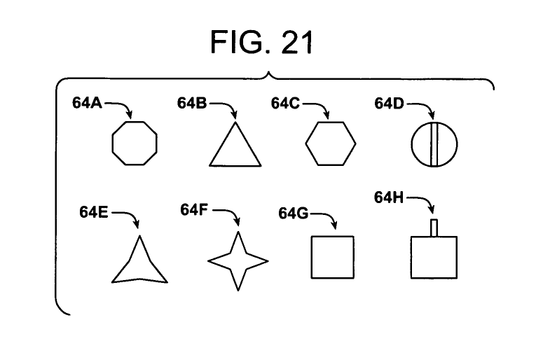

Referring to FIGS. 20 and 21, another aspect of this invention is a torque wrench kit that includes at least two of the torque wrenches 42, each torque wrench capable of threadably installing a support member to a different predetermined torque. For example, as depicted in FIG. 20, six (6) torque wrenches 42a-42f are depicted wherein there are two (2) torque wrenches having the same predetermined maximum torque, i.e., 25, 30 and 35 N-cm. Preferably the dentist/prosthodontist will have a selection of torque wrenches available with different torque limit values. A preferred method of coding the wrenches for different torque limits is by an indicia 70 which can indicate the absolute predetermined N-cm and/or by color coding. A preferred color coding can be by forming the torque wrench 42 or torque wrench cap 88 out of plastics that contain different color pigments.

The kit further includes six (6) drivers 46a-46f that are essentially identical to each other except for the driver tips 64 at the end of the driver shaft 62. As depicted in FIG. 21, each driver tip 64a-64h has a differing tip configuration 64 to couple to a different support member that needs to be screwed into the implant. For example, as depicted in FIG. 21, the tips may be octagonal 64a, triangular 64b, hexagonal 64c, slotted 64d, three-star shaped 64e, four-star shaped 64f, square 64g and square/slotted 64h.

Referring to FIGS. 1, 2 and 20, a matching wrench 44 is provided in the kit. The matching wrench 44 has one end that has a coupling surface 56a that interlocks with the sidewall 88c of each wrench cap 88 to tighten the wrench cap 88 to the predetermined torque. The wrench 44 has on the other end thereof a coupling surface 56b that interlocks with the sidewall 61 of each of the driver heads 60 to threadably uninstall the support member 40 without the torque wrench attached. Each of the coupling surfaces has a lip thereon 66 which assists in maintaining the wrench 44 in place on the driver head 60 and wrench cap 88.

In this description various dimensions are provided for the different elements. It should be understood that these dimensions are only approximate, only relate to the preferred embodiment and that various other dimensions may be suitable for this invention and that the invention should not be so limited.

While various changes may be made in the detailed construction and processes of this invention, it will be understood that such changes will be within the spirit and scope of the present invention. Having thus described the invention in detail, it is to be understood that the foregoing description is not intended to limit the spirit and scope thereof. What is desired to be protected by Letters Patent is set forth in the appended claims.

What is claimed is:

1. A torque wrench to which a driver member is attached for use in threadably installing to a predetermined torque, a support member for a dental prosthesis, the torque wrench comprising:
a torque wrench body having a proximal end and a distal end;
a cylindrical member having a proximal end and a distal end, the member passing through the proximal end and distal end of the wrench body and axially rotatable therein;
a torque wrench cap for placement on the proximal end of the wrench body, the wrench cap having an upper surface and a lower surface, wherein the wrench cap is fixedly mounted to the proximal end of the cylindrical member and the lower surface of the wrench cap has a plurality ridges and grooves radially disposed therein, whereby the wrench cap is axially rotatable with respect to the wrench body;
wherein the wrench body has a plurality of cylindrical bores therein circumferentially and axially distributed around the cylindrical member, each bore having a closed bottom on one end and an opening on the other end at the proximal end of the wrench body;
a compression spring member in each bore;
a rotatable ball within each bore supported on each spring member, a portion of the ball protruding from the opening and in springed contact with a groove in the lower surface of the wrench cap;
a means for removably mounting the driver member to the distal end of the cylindrical member to secure the driver to the distal end of the wrench body;
whereby when the wrench cap is rotated, the rotatable balls in the wrench body springedly secure the wrench cap to the wrench body and the wrench body and driver member axially rotate to threadably install the support member;
whereby when the support member is threadably installed to the predetermined torque the plurality of balls are depressed by the ridges in the lower surface of the wrench cap, compressing the springs in the bores, and the wrench cap rotates with respect to the wrench body to prevent further threadable installation of the support member.

2. The torque wrench of claim 1, wherein the torque wrench cap and torque wrench body are cylindrical.

3. The torque wrench of claim 2, wherein the torque wrench cap has a sidewall connecting the upper surface and lower surface, said sidewall having axial grooves therein that are equidistant from each other.

4. A torque wrench to which a driver member is attached for use in threadably installing to a predetermined torque, a support member for a dental prosthesis, the torque wrench comprising:
a cylindrical torque wrench body having a proximal end and a distal end;
a cylindrical member having a proximal end and a distal end, the member passing through the center of the proximal end and distal end of the wrench body and axially rotatable therein;
a cylindrical torque wrench cap for placement on the proximal end of the wrench body, the wrench cap having an upper surface and a lower surface, wherein a sidewall connects the upper surface and lower surface, the sidewall having axial grooves therein that are equidistant from each other, and the lower surface of the wrench cap has a plurality ridges and grooves radially disposed therein,
wherein the wrench cap is fixedly mounted to the proximal end of the cylindrical member and is axially rotatable with respect to the wrench body;
wherein the wrench body has a plurality of cylindrical bores therein circumferentially and axially distributed around the cylindrical member, each bore having a closed bottom on one end and an opening on the other end at the proximal end of the wrench body;
a compression spring member in each bore;
a rotatable ball within each bore supported on each spring member, a portion of the ball protruding from the opening and in springed contact with a groove in the lower surface of the wrench cap;
a means for removably mounting the driver member to the distal end of the cylindrical member to secure the driver to the distal end of the wrench body;
whereby when the wrench cap is rotated, the rotatable balls in the wrench body springedly secure the wrench cap to the wrench body and the wrench body and driver member axially rotate to threadably install the support member;
whereby when the support member is threadably installed to the predetermined torque the plurality of balls are depressed by the ridges in the lower surface of the wrench cap, compressing the springs in the bores, and the wrench cap rotates with respect to the wrench body to prevent further threadable installation of the support member.

5. A combination torque wrench and driver, wherein the driver member is for use in threadably installing to a predetermined torque, a support member for a dental prosthesis, the torque wrench comprising:
a torque wrench body having a proximal end and a distal end;
a cylindrical member having a proximal end and a distal end, the member passing through the proximal end and distal end of the wrench body and axially rotatable therein;
a torque wrench cap for placement on the proximal end of the wrench body, the wrench cap having an upper surface and a lower surface, wherein the wrench cap is fixedly mounted to the proximal end of the cylindrical member and the lower surface of the wrench cap has a plurality ridges and grooves radially disposed therein, whereby the wrench cap is axially rotatable with respect to the wrench body;
wherein the wrench body has a plurality of cylindrical bores therein circumferentially and axially distributed around the cylindrical member, each bore having a closed bottom on one end and an opening on the other end at the proximal end of the wrench body;
a compression spring member in each bore;
a rotatable ball within each bore supported on each spring member, a portion of the ball protruding from the opening and in springed contact with a groove in the lower surface of the wrench cap;
a driver member removably mounted to the distal end of the cylindrical member and the distal end of the wrench body, the driver member having a driver head on the proximal end and a tip configuration on the distal end that removably couples to the support member;
whereby when the wrench cap is rotated, the rotatable balls in the wrench body springedly secure the wrench cap to the wrench body and the wrench body and driver member axially rotate to threadably install the support member;
whereby when the support member is threadably installed to the predetermined torque the plurality of balls are depressed by the ridges in the lower surface of the wrench cap, compressing the springs in the bores, and the wrench cap rotates with respect to the wrench body to prevent further threadable installation of the support member.

6. The combination torque wrench and driver of claim 5, wherein the driver head is threadably mounted to the distal end of the cylindrical member.

7. The combination torque wrench and driver of claim 5, wherein the torque wrench cap, torque wrench body, and driver head are cylindrical.

8. The combination torque wrench and driver of claim 7, wherein the torque wrench cap has a sidewall connecting the upper surface and lower surface, said sidewall having axial grooves therein that are equidistant from each other.

9. The combination torque wrench and driver of claim 7, wherein the driver head has a sidewall having axial grooves therein that are equidistant from each other.

10. The combination torque wrench and driver of claim 5, wherein and the torque wrench cap, and driver head are cylindrical and substantially the same diameters, each having substantially identical axial grooves therein that are equidistant from each other.

11. A torque wrench kit comprising:
at least two of the torque wrenches of claim 5, each torque wrench capable of threadably installing a support member to a different predetermined torque.

12. A torque wrench kit comprising:
at least two of the combination torque wrenches and drivers of claim 5, each torque wrench capable of threadably installing a support member to a different predetermined torque and each driver having a differing tip configuration to couple to a different support member.

13. A torque wrench kit comprising:
at least two of the combination torque wrenches and drivers of claim 5,
each torque wrench capable of threadably installing a support member to a different predetermined torque, and
each driver having a differing tip configuration to couple to a different support member,
wherein all of the torque wrench caps, torque wrench bodies, and driver heads are cylindrical and all of the wrench caps have a sidewall connecting the upper surface and lower surface of the wrench cap, the sidewall having axial grooves therein that are equidistant from each other, and wherein all of the driver heads have a sidewall having axial grooves therein that are equidistant from each other; and
a matching wrench having one end that has a coupling surface that interlocks with the sidewall of each wrench cap to tighten the wrench cap to the predetermined torque, and another end that interlocks with the sidewall of each of the driver heads to threadably install or uninstall the support member without the torque wrench attached.

14. A torque wrench kit comprising:
at least two of the combination torque wrenches and drivers of claim 5,
each torque wrench capable of threadably installing a support member to a different predetermined torque, and
each driver having a differing tip configuration to couple to a different support member,
wherein each of the torque wrench caps, torque wrench bodies, and driver heads are cylindrical, and all of the wrench caps have a sidewall connecting the upper surface and lower surface of the wrench cap, each sidewall having axial grooves therein that are equidistant from each other, and wherein all of the driver heads have a sidewall having axial grooves therein that are equidistant from each other, wherein all of the torque wrench caps and driver heads are substantially the same diameter, each having substantially identical axial grooves therein that are equidistant from each other; and
a matching wrench having one end that has a coupling surface that interlocks with the sidewalls of each the wrench caps to tighten such wrench cap to its predetermined torque and that also interlocks with the sidewall of each of the driver heads to threadably install or uninstall the support member without the torque wrench attached.

15. A torque wrench to which a driver member is attached for use in threadably installing to a predetermined torque, a support member for a dental prosthesis, the torque wrench comprising:
a torque wrench body having a proximal end and a distal end;
a cylindrical member having a proximal end and a distal end, the member passing through the proximal end and distal end of the wrench body and axially rotatable therein;
a torque wrench cap for placement on the proximal end of the wrench body, the wrench cap having an upper surface and a lower surface, wherein the wrench cap is fixedly mounted to the proximal end of the cylindrical member and the lower surface of the wrench cap has a plurality ridges and grooves radially disposed therein, whereby the wrench cap is axially rotatable with respect to the wrench body;
wherein the wrench body has a cylindrical bore therein, the bore having a closed bottom on one end and an opening on the other end at the proximal end of the wrench body;
a compression spring member in the bore;
a rotatable ball within the bore supported on the spring member, a portion of the ball protruding from the opening and in springed contact with a groove in the lower surface of the wrench cap;
a means for removably mounting the driver member to the distal end of the cylindrical member to secure the driver to the distal end of the wrench body;
whereby when the wrench cap is rotated, the rotatable ball in the wrench body springedly secures the wrench cap to the wrench body and the wrench body and driver member axially rotate to threadably install the support member;
whereby when the support member is threadably installed to the predetermined torque the ball is depressed by the ridges in the lower surface of the wrench cap, compressing the spring in the bore, and the wrench cap rotates with respect to the wrench body to prevent further threadable installation of the support member.
